(19) United States
(12) Patent Application Publication
(10) Pub. No.: US 2021/0281982 A1
(43) Pub. Date: Sep. 9, 2021

(54) DYNAMIC GROUPING IN A COMMUNICATION DEVICE

(71) Applicant: TAIT INTERNATIONAL LIMITED, Christchurch (NZ)

(72) Inventors: John Alexander DRURY, Christchurch (NZ); Thilina Mallawa ARACHCHI, San Jose, CA (US); Max CHOI, Christchurch (NZ)

(73) Assignee: TAIT INTERNATIONAL LIMITED, Christchurch (NZ)

(21) Appl. No.: 17/193,011

(22) Filed: Mar. 5, 2021

Related U.S. Application Data
(60) Provisional application No. 62/985,373, filed on Mar. 5, 2020.

(51) Int. Cl. H04W 4/08; H04W 4/10; H04W 76/11; H04W 4/80

(52) U.S. Cl. CPC H04W 4/08; H04W 4/10; H04W 84/042; H04W 4/80; H04W 76/11

(57) ABSTRACT

A method of forming a group from wireless devices by bringing the devices into proximity. Particularly a combined smart mic and LMR radio. Each device sends LMR identity and group information to a server which creates the group. The devices are then advised of their group membership. Further devices may join an existing group.

This application claims priority of U.S. Provisional Application No. 62/985,373, filed Mar. 5, 2020, which is incorporated herein by reference, in its entirety.

### FIELD OF THE INVENTION

This invention relates to Push To Talk (PTT) operation in a combined Land Mobile Radio (LMR) and cellular communication system. More particularly this invention relates to an apparatus enabling the creation of dynamic communication groups to operate in a wireless device where the communications channels may be LMR Voice or PTT Voice using Voice Over IP technology.

### BACKGROUND TO THE INVENTION

Land Mobile Radio (LMR) systems traditionally support PTT operation from a hand-held radio or through the use of a speaker mic. Typically, the radio is worn on a belt around the waist and the speaker mic is attached to a lapel. A cable is typically used to connect the radio to the speaker mic and the speaker mic is typically acting as an extension to the user interface of the radio. Radio users typically operate in groups where membership of the group is typically established through a central configuration by an administrator.

LMR is a technology that supplies a PTT voice service that operates over communication technology specifically optimized for voice. Examples of LMR technology include but are not limited to P25 (APCO 25), Tetra, DMR (Digital Mobile Radio), or analogue LMR. LMR PTT voice service typically operates using an LMR server that forms a central controller to which all the LMR radios connect to for service. LMR can also operate in a mode where no central controller is present, this is commonly referred to as direct mode.

Push To Talk over Cellular (PTToC) solutions are typically implemented as smart phone applications and operate over a number of packet based technologies such as 4G, 3G and Wifi. PTToC solutions emulate LMR radio operation which means supporting one group conversation at a time. PTToC services typically operate over cellular networks connecting to a PTToC server that may be physical or cloud based.

Push to Talk solutions using LMR and Push To Talk over Cellular (PTToC) solutions are used by professional users such as emergency services for voice communication. Historically these professional users have developed operational procedures built around the communication technology they are using. There exists a need today to enable users to create dynamic groups for day to day operations. Whereas LMR does allow for dynamic group creation the process for creating such groups is limited by the technology and one cannot simultaneously operate on a main group and a separate group.

Typically, users of LMR and PTToC create new groups that are related to their current operation. Examples might include a job dispatch group or a tactical group or a local group. Users can select multiple groups to monitor for activity however when the user starts using one particular group for voice communication they lose contact with other groups temporarily. The only exception to this might be a priority group that may interrupt a current conversation if activity starts on a priority group. In other words LMR and PTToC support one group at any instant.

### SUMMARY OF THE INVENTION

The invention resides in a method and apparatus to enable creation or joining of a new LMR or VOIP communication group by way of device proximity.

In this description a portable radio connected to a smart mic is used by way of example of the apparatus. The same algorithms apply in a mobile (or vehicle radio) where upon LMR and LTE connections are available. Further, the smart mic can operate independently of a LMR radio.

The system from which LMR is originating can be any type of LMR including but not limited to P25 (APCO 25), Tetra, DMR (Digital Mobile Radio), or analogue LMR. The apparatus described here applies to any form of network including trunked, conventional and direct mode.

### LIST OF FIGURES

Preferred embodiments of the invention will be described with respect to the accompanying drawings, of which:

FIG. 1 shows a typical LMR radio attached to a standard speaker/mic,

FIG. 2 shows a typical LMR radio connected to a smart mic,

FIG. 3 shows an overview of the smart mic architecture,

FIG. 4 shows a front view of the smart mic,

FIG. 5 shows a side view of the smart mic illustrating two independent PTT buttons,

FIG. 6 shows a system view across LMR and PTToC network,

FIG. 7 illustrates how devices are brought in proximity to one another using NFC,

FIG. 8 shows an example of group membership,

FIG. 9 shows a method of creating a dynamic group through physical proximity,

FIG. 10 shows a method of creating and removing groups at the server,

FIG. 11 shows how proximity of smart mics with associated LMR radios can be used to create dynamic LMR groups,

FIG. 12 shows a method for producing dynamic LMR groups,

FIG. 13 shows how geographic location can be used to establish a group,

FIG. 14 shows a process for creating a geographic group.

### DESCRIPTION OF PREFERRED EMBODIMENTS

Referring to the drawings it will be appreciated the invention may be performed in a variety of ways in relation to many forms of wireless device, particularly a combined smart mic and LMR radio.

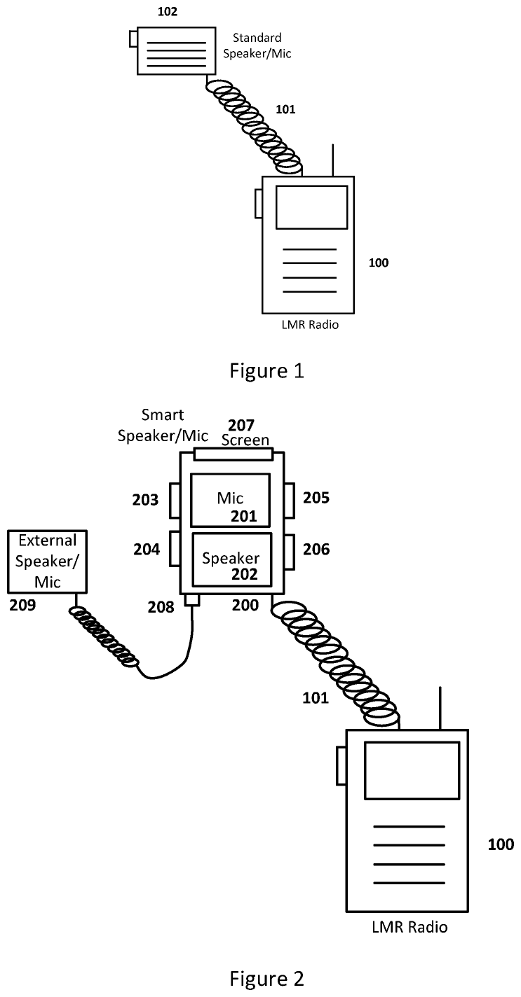

FIG. 1 shows a typical configuration of an LMR radio 100 connected to a standard speaker mic 102 through a cable 101. This is a common configuration used in the field today. For example a police officer may be wearing an LMR radio 100 on a belt and a cable 101 may run up the body to a speaker mic located on a lapel or another convenient position. The cable 101 typically carries audio signals, push-to-talk (PTT) signals and may enable digital interaction with the LMR radio 100 if that function is enabled. This type of speaker mic 102 typically has minimal processing capability and represents an extension of the functionality of the attached LMR radio.

FIG. 2 shows a smart mic 200 having its own processor separate from the associated LMR radio 100. The smart mic is optionally connected to the LMR radio 100 via a cable 101 that may be the functionally the same as that described in FIG. 1 or may have additional lines. The smart mic 200 contains one or more microphones 201 and one or more speakers 202 and one or more function buttons. In this case two PTT buttons are shown 203 and 204 and two other buttons 205 and 206 represent general function buttons such as report location or emergency button. All the buttons are configurable. Display 207 represents a screen on the top of the device, visible to a user from above. An external speaker 209 is also shown connected via cable to a connection 208. This is a typical configuration where the external speaker may be worn in the ear. Even though cables are shown here, an alternative option would be to use wireless such as Blue Tooth.

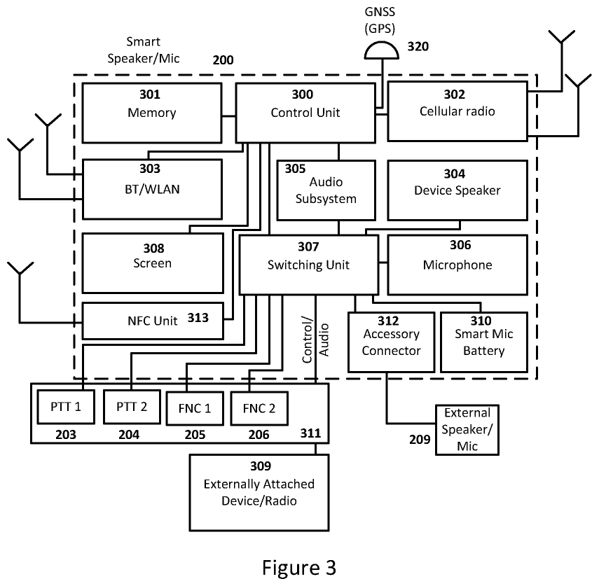

FIG. 3 offers a system description of a smart mic 200. The smart mic contains a control unit 300 which is a processor that implements control and communication functions. The control unit connects to a GPS unit 320 for the purpose of reading smart mic location. For convenience in this document the US technology is described which is GPS however all forms of Global Navigation Satellite System (GNSS) are included. The computer programs that implement the algorithms on the platform are contained within local memory 301 and executed on the smart mic. The smart mic optionally contains a cellular radio 302 used for communicating over the cellular network. The cellular radio 302 is connected to the control unit 300. The smart mic contains a Bluetooth and or WLAN unit 303 used for communicating to local equipment over this medium. The Bluetooth and or WLAN 303 are connected to the control unit 300. The smart mic also contains a Near Field Communications (NFC) unit 313. The NFC technology enables devices placed within proximity to one another to exchange relevant information such as device identity.

The smart mic also contains one or more microphones 306 and one or more speakers 304 and one or more function buttons 203, 204, 205 and 206. These are connected to the control unit 300 via a switching control unit 307 and/or the audio subsystem 305. Audio subsystem processing may include adjusting audio levels, injecting audio, audio mixing, automatic noise cancellation, echo cancellation and audio filtering. The smart mic also contains a local power source 310 that in this case is a battery. A screen, 308 is used to render information for the benefit of the user and this is connected to the control unit 300. Also connected to the switching unit is an externally attached device 309 that in this case is an LMR radio. This LMR radio may be a handheld unit that operates from a battery. Alternatively, the LMR radio may be installed in a vehicle. In the LMR industry this is typically referred to as a mobile radio that operates from a vehicle power supply. A rotatable connector (RC), 311 is also shown which allows the cable 101 to be connected in either an up or down configuration. Also shown is an accessory connector 312 that represents an interface to connecting external devices such as an external speaker or speaker mic 209.

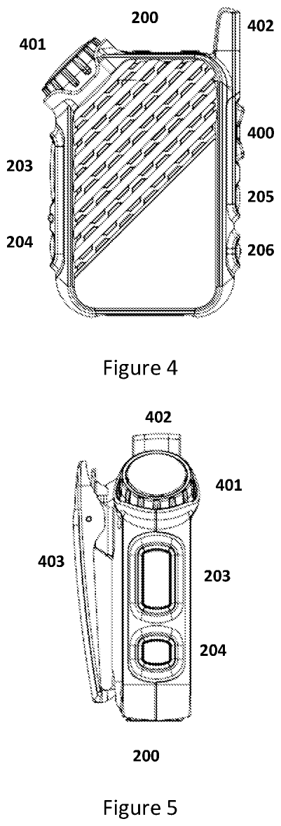

FIG. 4 shows a front view of the smart mic implementation 200. It shows the realisation of the PTT buttons 203 and 204 on the left side. Having two PTT buttons is one aspect of enabling two simultaneous groups. The function buttons 205 and 206 are shown on the right along with a rocker switch 400 for selecting user workflows. A rotary encoder 401 is shown that can be used for channel selection or menu functions. Antenna 402 illustrates the device antenna.

FIG. 5 shows a side view of the smart mic 200. This highlights the PTT buttons 203 and 204 to enable dual simultaneous groups. In one configuration 203 and 204 may be assigned to two VOIP groups. In another configuration 203 and 204 may be assigned to one VOIP group and one LMR group respectively. Clip 403 represents a clip for attaching the device to the user's clothing. The rotary encoder 401 is also shown with the antenna 402 in the background.

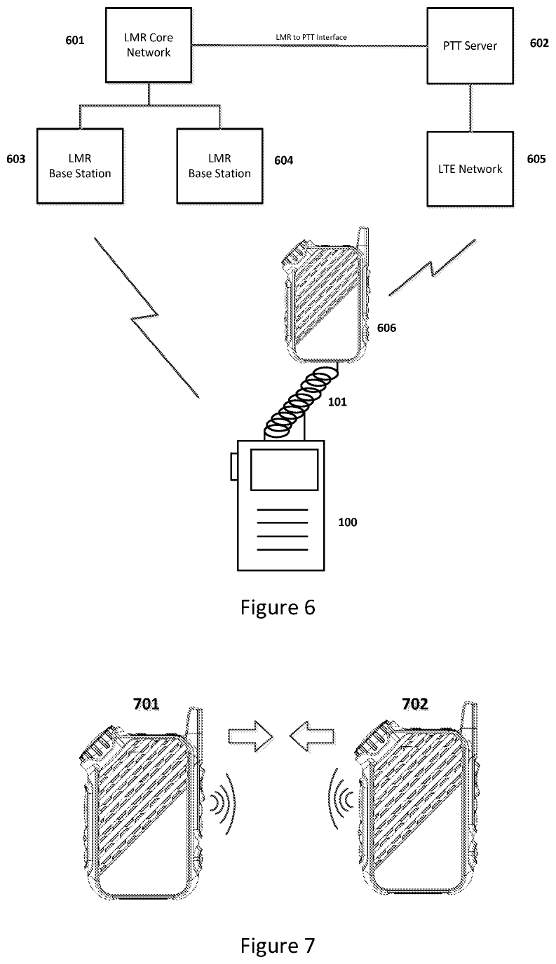

FIG. 6 shows a system diagram containing both an LMR network and a PTT or VOIP network. The LMR core network 601 is a server responsible for managing allocation of LMR resources and managing LMR groups. It coordinates assignments of channels across the base stations 603 and 604 and usually many others to enable a number of LMR radios 100 to communicate voice within groups, traditionally called talkgroups in LMR.

A PTT or VOIP server, 602 is also shown. These are typically based on SIP technology and manage the groups of VOIP users including which VOIP capable devices such as the smart mic 606 become members of selected groups. VOIP operates across packet based communication networks such as LTE to afford mobile operation to the VOIP capable device 606.

FIG. 6 shows an interface between the LMR core network 601 and the PTT server 602. This interface enables the core networks to exchange information such as group membership. There can be membership of either VOIP group based on the smart mic or an LMR group based on the LMR radio. The smart mic 606 is connected to the radio 100 via a cable 101. This connection enables the smart mic to read information such as radio ID, group membership and signal strength from the radio 100.

FIG. 7 illustrates how bringing two smart mics in proximity that are both enabled with NFC is used to trigger the exchange of information such as device or user identity so that a dynamic group can be formed. The devices are shown vertically however any device orientation is relevant as NFC communication is generally isotropic.

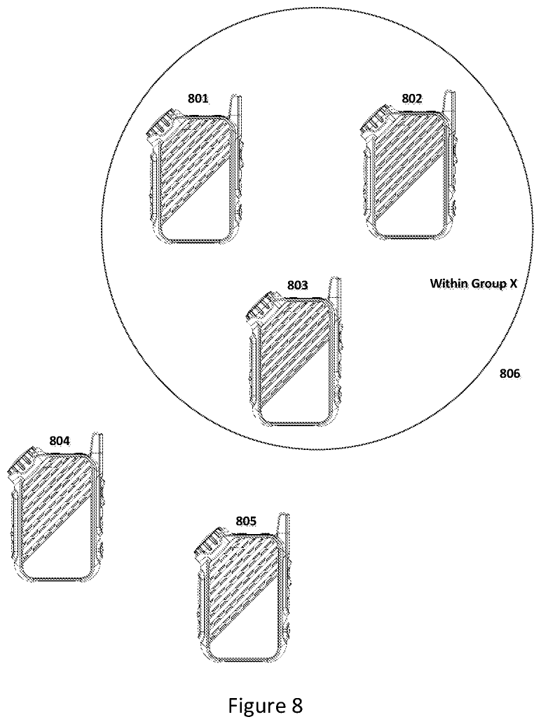

FIG. 8 shows an example of group membership. In the example, smart mic units 801, 802 and 803 are all members of an existing local group X illustrated with the circle 806. Units 804 and 805 however are not members of group X although if for example unit 805 were to be partnered (brought in proximity of) unit 803 then unit 805 could become a member of group X. Proximity is typically very close such as 10 cm or less for example, or may require physical touching, with suitable notification to the users when partnering has been achieved.

Each device knows its current group memberships through a stored list cached in the memory of the device 301. As a result if one of the devices is already a member of a group then it can be detected. Selection of which group should be joined is accomplished in a number or ways, Referring to FIG. 8, units 801 to 803 are already members of group X. As a result when 803 is placed in proximity with 805 then 805 is seeking to join group X.

Alternatively the user can initiate the creation of a new group from the device interface 207. Creating a new group may create an empty group Z. Initially there is only one device in that group until pairing starts to bring other users into the group.

Common use cases will be a) for a user to either select a group X that already exists and add one or more devices to it or b) to create an entirely new group Z and add devices to that.

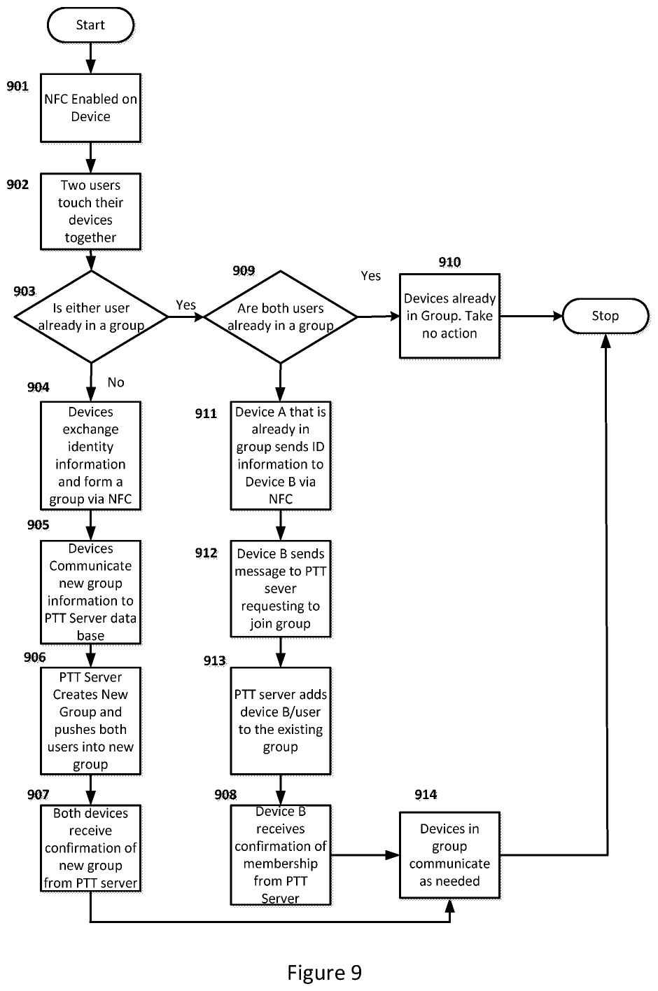

FIG. 9 illustrates a process for creating a dynamic group. In step 901, the smart mics have NFC enabled. This enables proximity detection and exchange of information for group formation. In step 902 two users bring or touch their devices together as described in FIG. 7. This results in in exchange of information. In step 903 a check is made to see if they are already members of a group X.

If the devices are not members of group X then in step 904 the devices exchange identity information including device identity via NFC and this is the first step to creating the group. In this case the device identity exchanged is that of the smart mic itself. In step 905 both devices communicate the new group information to the data base in the PTT server that is implemented on the cloud. In step 906 the PTT server in the cloud creates the new group an puts the devices into that group. In step 907 both units are sent confirmation of the new group and in step 914 the group members can communicate normally. The information from device A informs the server it is joining a group with device B. The information from device B informs the server it is joining a group with device A. The PTT server uses these dual messages to confirm that A is joining B and B is joining A.

During step 903, if a device is already a member of group X then in step 909 a check if made to see if both devices are already in the group X. If they are both in group X then in step 910 no action is taken and the procedure stops. If one of the devices is in the group then we move to step 911.

In step 911 the device A that is already in group X sends ID information to device B via NFC. In step 912 device B send a message to the PTT server containing its own ID and the group ID of group X requesting membership of group X. Device A may send confirmation to the server. In step 913, the PTT server adds device B to the existing group X. In step 908, the PTT server sends confirmation of group membership to device B or alternatively sends group member ship to both device A and device B where upon in step 914 the group members can communicate normally.

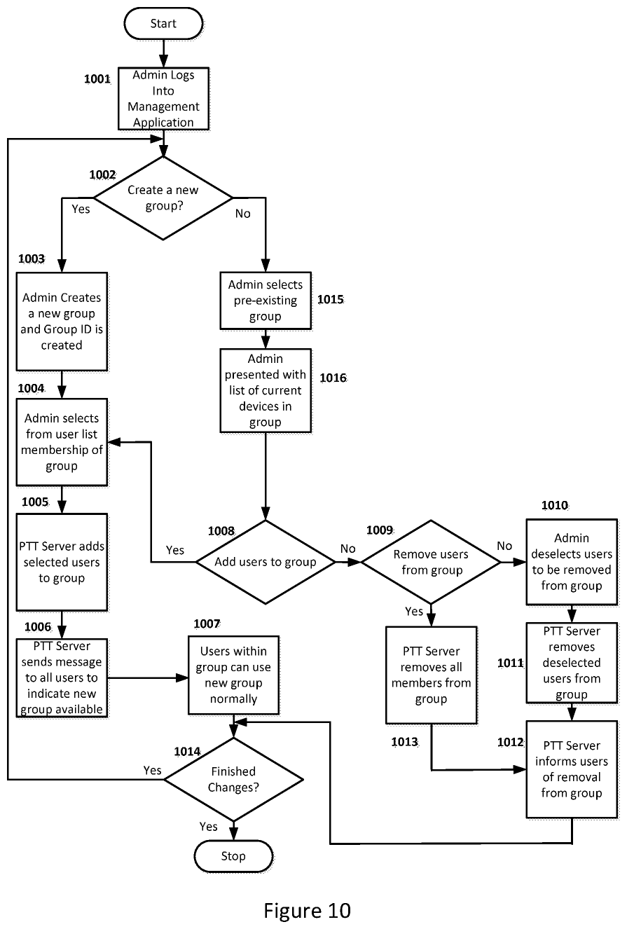

FIG. 10 shows a process in the PTT server that allows an administrative user to create and change groups manually. In step 1001, the administrative user logs into the PTT server through a management application. In step 1002 the administrative user selects if they wish to create a new group or not.

In step 1002, if they choose to create a new group then in step 1003 the admin user enters a new group ID and that group Y is created as an empty set. In step 1004, the admin user selects from a user/device list which members they would like to include in the new group Y. In step 1005 the PTT server adds those users to the new group Y. In step 1006 the PTT server sends a message to all group members informing then they have been added to a new group. In step 1007 the new members of group Y can use the group normally and in step 1014 a check is made to see if any further changes are needed. If they are then the system returns to step 1002. If they are not then the process stops and the user is logged out.

In step 1002, if they choose not to create a new group then in step 1015 the admin user is presented with the list of existing groups such as X. In step 1016 the admin user is presented with the current group membership of group X. In step 1008 the admin user is asked if they wish to add more users to the group X. If they do then in step 1004 the admin user can select more users to add before they are added in step 1005.

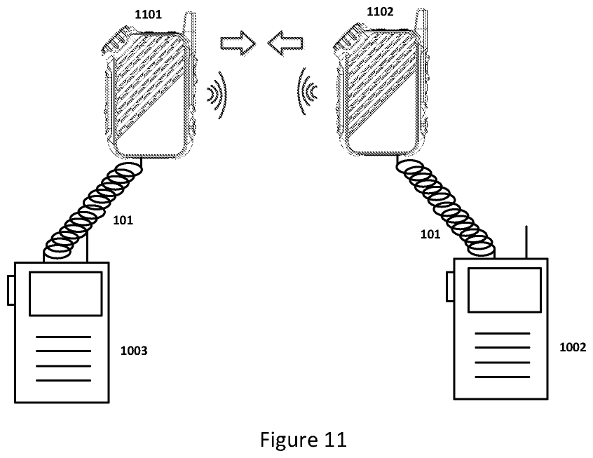

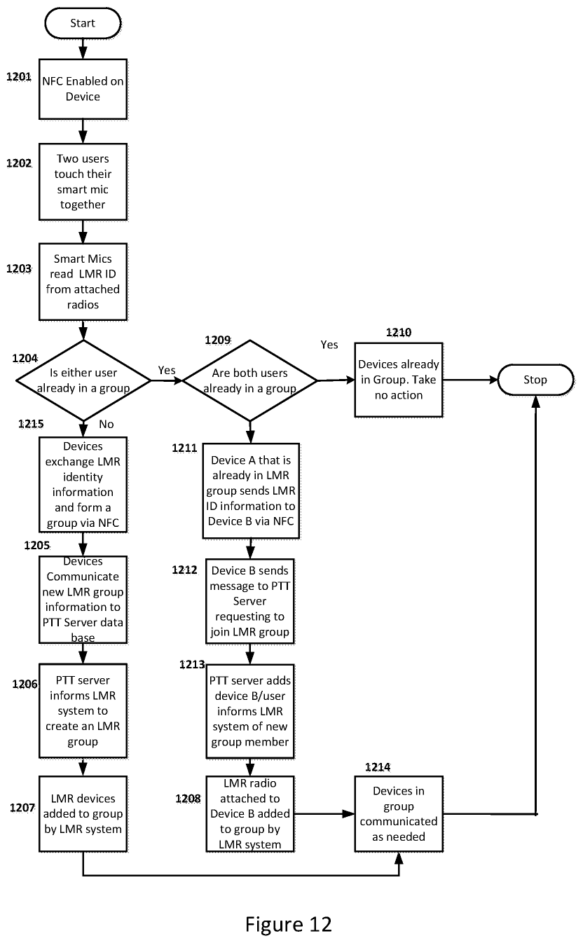

FIG. 11 shows and example of dynamic group creation though on this occasion the smart devices 1101 and 1102 are both connected to LMR radios 1003 and 1002 respectively via cables 101. In this case the smart mics are brought within proximity of one another using NFC to communicate and rather than establishing a VOIP group, in this case an LMR group is created as described in FIG. 12.

FIG. 12 shows a process for dynamically creating an LMR group. In step 1201 the NFC systems are enabled by the users in both the smart mic devices 1101 and 1102 shown in FIG. 11. In FIG. 12 the users touch together the smart mic devices 1101 and 1102 which are able to communicate via NFC.

In step 1203, the smart mics 1101 and 1102 read the LMR ID and group membership from the attached LMR radios 1003 and 1002 respectively.

In step 1204 a check is made to see if either LMR radio is already in a new group Z. If they are not presently in a new group Z then in step 1215 the smart mic devices exchange information including the LMR IDs to create a new group Z via NFC. In step 1205 the smart mic devices both communicate the new LMR group information to the PTT server data base. In step 1206 the PTT server 602 informs the LMR server 601 to create a new group Z and the LMR server adds the LMR radios 1003 and 1002 to the new group Z. In step 1214 the LMR devices in the new group Z can operate normally.

In step 1204, if the check reveals that one of the users/devices is already in a group then in step 1209 a check is made to see if both devices are already in a group. If they are in a group then in step 1210 no action is taken and the process stops. If one of the devices is not within a group then in step 1211, device A (1101) that already has an attached LMR radio in the group sends its LMR ID information and the group ID to the device B (1102). In step 1212 device B (1102) sends a message to the PTT server requesting to join the LMR group Z. In step 1213 the PTT server informs the LMR server to add the new user/device (1102) to the LMR group Z. In step 1208 the LMR radio (1002) attached to the smart device B (1102) receives an update from the LMR server to inform it that it has been added to group Z. In step 1214 the LMR devices in the new group Z can operate normally.

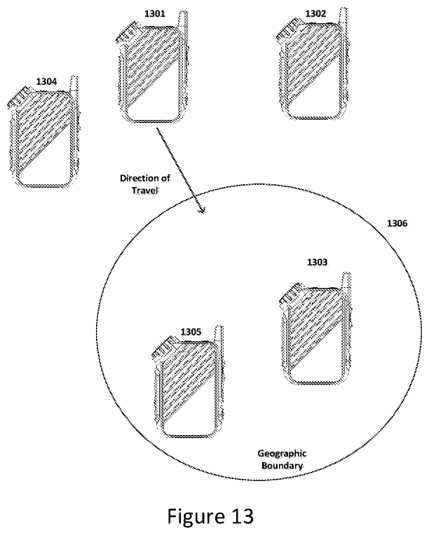

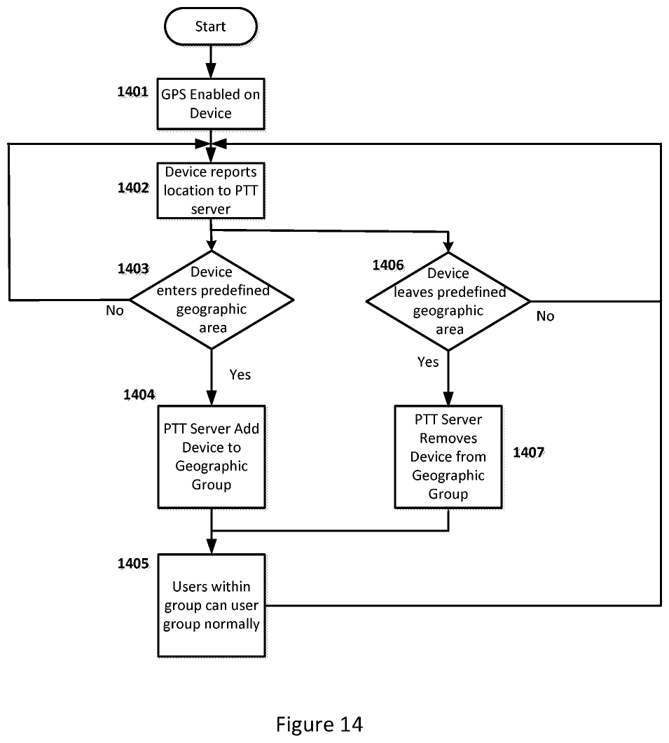

FIG. 13 illustrates geographically formed communication groups by way of comparison with proximity formed communication groups. Smart Mic devices 1305 and 1303 are illustrated within a geographic boundary 1306 which means they are in a geographic based group. Smart mic devices 1304 and 1302 are shown outside the geographic group. Device 1301 however is shown moving in a direction which means it will enter the geographic areas defined by 1306 and then become a geographic group member as described in FIG. 14. The geographical boundary may be pre-defined or setup manually or automatically at the time the group needs to be established. One example may be a accident scene whereupon the geographic boundary would be defined at that time,

FIG. 14 shows a process for creating geographic groups. In step 1401, the GPS units are enabled on the smart mic devices. This is needed to enable operation of geographic groups. In step 1402 the smart mic devices periodically report their location to the PTT server. In step 1403 the PTT server checks if any device has entered a certain geographic area 1306. If no new device has entered geographic area 1306 then the smart mic devices continue to report location as shown in step 1402. If during step 1403 a new device such as 1301 has entered the geographic areas 1306 then in step 1404 the PTT server adds the device 1301 to the geographic group 1306 whereupon in step 1405 the group members can communicate normally.

1. A method of creating a communication group with two or more wireless devices, including the steps of;
bringing two devices into proximity with one another,
exchanging device identity and group information between the devices,
informing a network server of the device identities and group information,
establishing a new group in the server, and
informing the devices they are now within the new group.

2. A method according to claim 1 wherein the devices are smart mics and the device identities are smart mic identities.

3. A method according to claim 1 wherein the devices are smart mics attached to LMR radios and the device identities are LMR identities.

4. A method according to claim 1 wherein both devices inform the server of the identity and group information before establishing the group.

5. A method according to claim 1 further including:
bringing a third device into proximity with either of the two devices,
informing the server of the third device identity information and the group, and
adding the third device to the group.

6. A method of providing group communication in a combined radio and smart mic device, including the steps of:
bringing two smart mics in proximity of one another,
reading LMR identities from their respective radios,
exchanging LMR identity and group information between the devices,
informing a network server of the LMR device identities and group information,
instructing an LMR system connected to the server to create a new LMR group,
adding the LMR devices to the group, and,
informing the LMR devices they are now within a new group.

7. A method according to claim 6 where the devices are smart mics connected to LMR radios.

8. A smart mic for use in group communications, including:
a processor, memory, cellular radio and a near field communication (NFC) unit,
the memory containing instructions and data which cause the processor to:
detect the presence of a nearby smart mic by way of the NFC unit,
determine whether a creating of a new group or joining of an existing group is required,
exchange identity and group information with the nearby smart mic,
transmit identity and group information to a server by way of the cellular radio, and
receive acknowledgement that the smart mic is now part of a new group or has joined an existing group.

9. A smart mic according to claim 8 wherein the new group or existing group is a VOIP group.

10. A smart mic according to claim 8 further including:
a connection to an associated LMR radio,
and the memory contains instructions which cause the processor to:
read LMR identity from the associated LMR radio as required for creating or forming an LMR group.
